(19) United States
(12) Patent Application Publication
(10) Pub. No.: US 2007/0143487 A1
(43) Pub. Date: Jun. 21, 2007

(54) Encoding Enhancement

(75) Inventors: Wei Zhong, Issaquah, WA (US); Andres Vega-Garcia, Newcastle, WA (US); Dalibor Kukoleca, Redmond, WA (US); Mu Han, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,214

(22) Filed: Dec. 19, 2005

(51) Int. Cl. G06F 15/16

(52) U.S. Cl. 709/230

(57) ABSTRACT

Encoded signal reuse implementations are described. In one implementation, an already encoded signal may be selected, in a favor of encoding a signal, if a parameter associated with the already encoded signal substantially matches an evaluation parameter used to select an encoding procedure. The implementations may also enable selection of an already encoded signal if encoding a signal would produce an encoded signal that is substantially the same as the already encoded signal.

### BACKGROUND

Video conferencing systems are becoming more popular in the United States and around the world. Many video conferencing systems are able to handle numerous incoming communication signals and are able to output a number of encoded signals for delivery to conference recipients. In one example, a party communicates audio and video signals to a number of users that have access to a video conferencing system. The video conferencing system ensures that the audio and video signals are in a format that can be consumed by the users.

Preparing and formatting audio and video signals for dissemination over a network often requires substantial processing resources. Before audio and video signals are sent over the network, the signals undergo an encoding process. This encoding process formats the signals so that they can be consumed by a receiving party. For example, an encoding process may evaluate a party's available network bandwidth and accordingly compress the signals so that they can be communicated over the network. Repeating this process for each recipient requires large processing resources and can limit a number of user conferences a conferencing system is able to handle.

### SUMMARY

Encoded signal reuse can increase the efficiency of a media server that receives and delivers media signals to users. The increase in efficiency may be achieved by reusing already-encoded media signals in favor of encoding a media signals before they are delivered to users. In one exemplary implementation, an evaluation process occurs before a signal is encoded. This evaluation process may include taking into consideration the composition of the signal, a network bandwidth that will be used to convey the signal once it is encoded, the capabilities of the device that will receive the signal after it is encoded, and a codec (compressor/decompressor) that would be used to encode the signal. If one or more of the evaluation parameters substantially match one or more parameters associated with an already-encoded signal, the already-encoded signal is selected in a favor of encoding the signal.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary communication arrangement. The arrangement includes a number of client computing devices in communication with a media server.

FIG. 2 illustrates various modules that may be implemented in a media server. In this figure, the media server is processing signals received from Users 1 and 2. Part of the processing includes delivering an encoded signal to a User 3.

FIG. 3 illustrates various modules that may be implemented in a media server. In this figure, the media server is processing signals received from the Users 1 and 2 and delivers an encoded signal to a User 4.

FIG. 4 illustrates various parameters that may be considered by an evaluation module before an encoding process is initiated. The evaluation module may be associated with a media server.

FIG. 5 illustrates a signal module that includes functional modules to encode signals and/or deliver encoded signals. The signal module may be a functional element of a media server.

FIGS. 6-8 illustrate flow diagrams of processes that encode signals or select encoded signals for communication to user computing devices.

FIG. 9 is a block diagram illustrating functional components in a computing device that could be used to implement one or more devices illustrated in the figures.

### DETAILED DESCRIPTION

Overview

The following disclosure describes an arrangement and/or method capable of reusing an already-encoded signal in favor of encoding a signal for dissemination to one or more users. In one implementation, an evaluation process occurs before a signal is encoded. This evaluation process may include taking into consideration the composition of the signal, a network bandwidth that will be used to convey the signal once it is encoded, the capabilities of the device that will receive the signal after it is encoded, and a codec that would be used to encode the signal. The foregoing are considered evaluation parameters that may be assessed before a signal is encoded. These evaluation parameters are compared against evaluation parameters belonging to already encoded signals. If the evaluation parameters of the signal to undergo encoding substantially match the evaluation parameters of an already encoded signal, the already encoded signal is selected and sent to a recipient. The original signal, which was to undergo encoding, is not encoded.

To distill the above, the various implementations described herein provide encoded-signal reuse. Encoded signal reuse has the potential to significantly reduce the processing requirements of a media server. This may increase a number of signals that the media server is able to process at any given moment.

An exemplary communication arrangement having a number of client computing devices in communication with a media server is described first. The description related to the communication arrangement is intended to provide context related to how a media server processes signals. The foregoing is followed by a description of an exemplary implementation of a media server and uses related thereto. Then, exemplary processes that encode signals or select encoded signals for communication to user computing devices are described. Finally, a general computing device is discussed.

An Exemplary Communication Arrangement

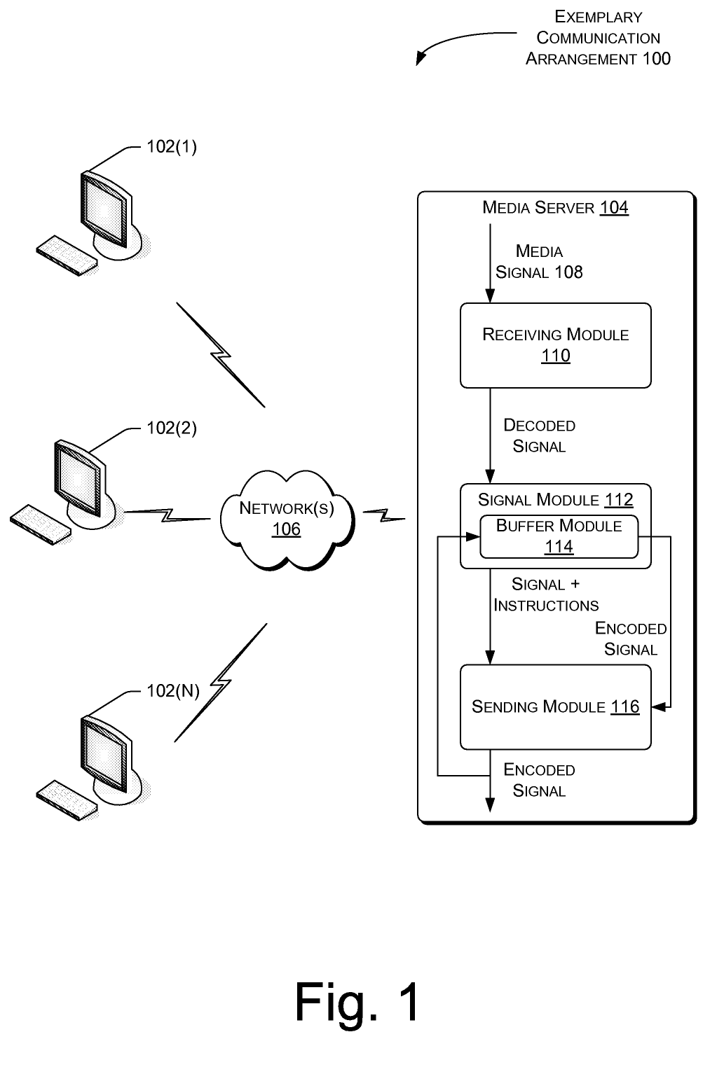

FIG. 1 illustrates an exemplary communication arrangement 100 that may be used in conjunction with various signal-encoding implementations described in the following. The exemplary communication arrangement 100 includes client computing devices 102(1) . . . 102(N) in communication with a media server 104. The communication between the computing devices 102 and the media server 104 is facilitated through a network 106. The network 106 is representative of many different types of networks, such as cable networks, the Internet, and wireless networks.

The media server 104 is designed to receive media signals, such as audio and video signals, and is able to communicate the received media signals to destination computing devices (e.g., the client computing devices 102). The phrases media signals or media signal, as used herein, are intended to refer to any media types, individually or collectively. These media types may include motion video, still video, audio, shared data, shared applications, and any other media in open or propriety standards that may be communicated over a network (e.g., the network 106).

The client computing devices 102 may represent computing devices used by users or subscribers during video conferences, or data conversations or conversations between devices or applications over a network (e.g., the network 106). Therefore, each of the client computing devices 102 may include a microphone and a speaker to capture and play audio signals. The client devices 102 may be further implemented with a camera and a display to capture and play video signals. The client computing devices 102 are illustrated as personal computers, but may also be implemented as other devices, such as a set-top box, a game console, a laptop computer, a portable digital assistant (PDA), a cellular phone, Voice over IP (VoIP) telephones, conventional phones, and so forth.

In one implementation, a client device 102 sends a media signal 108 over the network 106 to the media server 104. This media signal 108 is for dissemination to a plurality of other client devices 102. The media server 104 facilitates the dissemination to the plurality of other client devices 102 by ensuring that the media signal 108 is in a format that can be received by the other client devices 102. To that end, the media server 104 may evaluate an amount of network bandwidth available to each of the client devices 102 that are to receive the media signal 108. An amount of network bandwidth available to a given client device is considered one parameter that can be used when choosing a signal encoding procedure.

The media signal 108 may go through several transformations, such as decoding and encoding, in the following description. For clarity, the reference “media signal 108” will remain consistent.

The amount of network bandwidth available to a destination client device may determine how the media signal 108 is encoded. For example, those client devices 102 that have broadband network connections, such as DSL and cable modem connections, can receive media signals encoded using a low-compression codec (compressor/decompressor). But, those client devices 102 that have dialup network connections, might only be able to receive media signals encoded using a high-compression codec.

As is shown in FIG. 1, the media server 104 includes a receiving module 110 that processes (decodes) incoming media signals. The media signals may be from one client device 102, or from a plurality of the client devices 102. In this case, the media signal 108 is decoded by the receiving module 110 and passed to a signal module 112.

The signal module 112 is generally responsible for selecting codecs used to encode media signals. When possible, the signal module 112 will select already-encoded signals in favor of choosing to encode media signals. Already encoded signals are held in a buffer module 114. The buffer module 114 is part of the signal module 112; this is by way of example only.

The already encoded signals held in the buffer module 114 have associated parameters. These parameters relate to information that was considered before the already encoded signals were encoded. In this implementation, an amount of network bandwidth available to each of the client devices 102 that are to receive the media signal 108 are being considered. Thus, if the media signal 108 were to undergo encoding, the amount of bandwidth available to a particular destination client device 102 would be associated with the signal 108 during the encoding process. Other parameters may include the composition of a signal, the capabilities of the device that will receive a signal after it is encoded, and a codec that would be used to encode a signal.

To convey an aspect of the implementation, suppose that the buffer module 114 does not contain any already encoded signals. Accordingly, the media signal 108 needs to undergo encoding before it is sent to the client device 102. To that end, the signal module 112 evaluates the amount of bandwidth available to the client device 102 that will receive delivery of the media signal 108. Based on the evaluation, the signal module 112 chooses a codec to encode the media signal 108. A codec lookup table may be employed by the signal module 112 to facilitate the codec-selection process.

The signal module 112 passes the media signal 108, along with instructions indicating a codec that should be used to encode the media signal 108, to a sending module 116. The sending module 116 retrieves the indicated codec, encodes the media signal 108 and delivers the encoded media signal 108 to the client device 102.

The signal module 112 also sends the encoded media signal 108 back to the signal module 112 for storage in the buffer module 114. The encoded media signal 108 is packaged with at least one associated parameter that can be later referenced. In this case, the associated parameter is the amount of bandwidth available to the destination client device 102 that received the encoded media signal 108.

The media signal 108 is for dissemination to many client devices 102. Conventional media conveying systems may encode the media signal 108 before each communication to respective ones of the client devices 102. To do this requires a very large amount of processing overhead.

The media server 104 may convey media signals with greater efficiency. The buffer module 114 now includes the encoded media signal 108. Those destination client devices 102 that have access to an amount of bandwidth that is relatively close to the associated parameter linked to the encoded media signal 108 can likely consume the encoded signal 108. Therefore, instead of encoding the media signal 108 for those destination client devices 102, the signal module 112 passes the encoded media signal 108, retrieved from the buffer module 114, to the sending module 116 with instructions to disseminate the already encoded signal 108 to one or more client devices 102. Eliminating the encoding process in the sending module 116 may enhance the efficiency of the media server 104.

In one implementation, the media server 104 encodes a media signal two times. One encoded signal is sent to destination computing devices that have high-bandwidth connections, such as a connection that can handle a bit rate greater than 56 Kbps. The other encoded signal is sent to destination computing devices that have low-bandwidth connections, such as a connection that cannot handle bit rates greater than 56 Kbps. The two encoded signals are stored in the media server 104 and each encoded signal has a respective associated parameter.

The respective associated parameters simply indicate a level of network bandwidth a destination computing device needs to have in order to properly receive the encoded signal. For example, one associated parameter may indicate that the encoded signal may be sent to destination devices that have high bandwidth connections. A client device is considered to have a high bandwidth connection if the device can handle bit rates greater than 56 Kbps. A client device is considered to have a low bandwidth connection if the device cannot handle bit rates greater than 56 Kbps.

In another example implementation, the media server 104 encodes a media signal two times. One encoded signal is sent to destination computing devices that have high-bandwidth connections, such as a connection that can handle a bit rate greater than 56 Kbps. The other encoded signal is sent to destination computing devices that have low-bandwidth connections, such as a connection that cannot handle bit rates greater than 56 Kbps. The signal for the low bandwidth connections is encoded using a 20 Kbps codec. The two encoded signals are stored in the media server 104 and each encoded signal has a respective associated parameter.

The respective associated parameters simply indicate a level of network bandwidth a destination computing device needs to have in order to properly receive the encoded signal. For example, one associated parameter may indicate that the encoded signal may be sent to destination devices that have high bandwidth connections. A client device is considered to have a high bandwidth connection if the device can handle bit rates greater than 56 Kbps. A client device is considered to have a low bandwidth connection if the device cannot handle bit rates greater than 56 Kbps.

Using the foregoing principles, for each destination computing device, the media server 104 conducts a simple bandwidth connection evaluation, references the associated parameters of the encoded media signals, and sends an appropriate one of the two encoded media signals to the device. More than two media signal encodings may be produced to support a greater number of bandwidth ranges.

In another implementation, the media server 104 encodes a media signal one time and sends the encoded signal to all of the recipient destination devices. Here, the media server 104 may encode the media signal as if all of the destination devices have low bandwidth connections. Although this technique saves having to encode the same media signal multiple times, it may be at the expense of those destination devices that have high bandwidth connections.

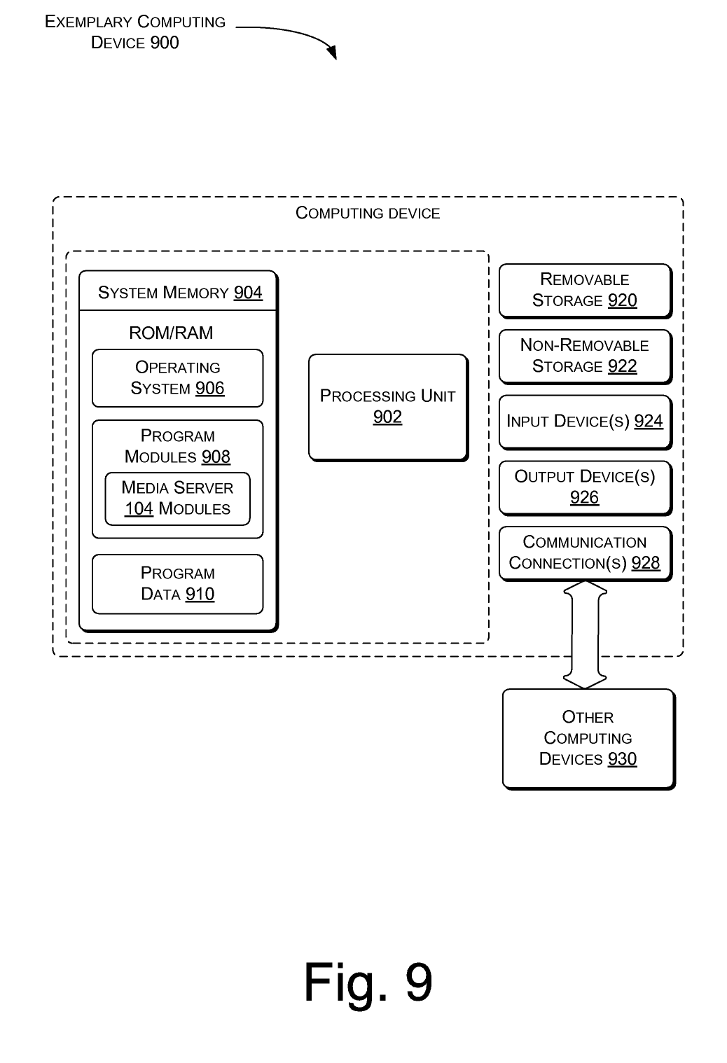

The devices, modules and elements illustrated in FIG. 1 may be implemented as software or computer-executable instructions stored in a memory of a client(s)/server(s) and executed by one or more processors of the client(s)/server(s). The memory may be implemented as non-removable persistent storage of the clients/servers, although other suitable computer storage media may also be used to store the modules and elements. An example of a computer device is provided below with reference to FIG. 9.

Exemplary Media Server Implementation

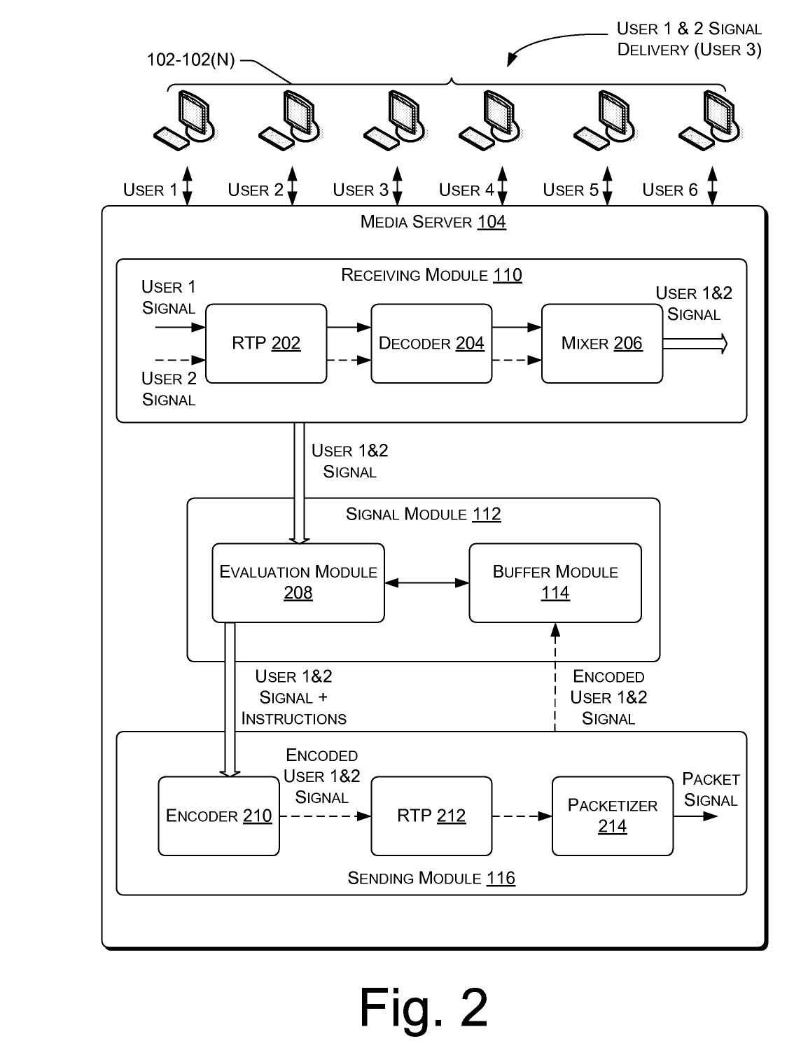

FIGS. 2-6 illustrate example implementations of the media server 104. In general, the media server 104 has processing capabilities and memory suitable to store and execute computer-executable instructions. Therefore, the media server 104 and its various elements and modules may be implemented as software or computer-executable instructions stored in a memory and executed by one or more processors thereof. The memory may be implemented as non-removable persistent storage, although other suitable computer storage media may also be used to implement the memory as well. The various elements and modules of the media server 104 may be implemented in hardware as well, or any other suitable implementation recognized by one having ordinary skill in the art. An exemplary computer system is provided below with reference to FIG. 9.

FIG. 2 illustrates a number of user computing devices 102 in communication with the media server 104. In this figure, the media server 104 is processing signals received from Users 1 and 2 and delivers an encoded signal to a User 3. The encoded signal delivered to User 3 comprises the signals received from the Users 1 and 2.

The Users 1-6 shown in the figure are participating in a collaborative video conference that may include one or more audio and video media signal exchanges between the Users. The media server 104 enables the conferencing functions of the collaborative video conference.

The receiving module 110 receives a User 1 signal and a User 2 signal. The signals may be audio or video media. If necessary, the User 1 and 2 signals are processed by a Real-Time Transport Protocol (RTP) module 200. As those skilled in the art appreciate, the RTP module 200 may be used to detect if there is any packet loss and to compensate for any delay jitter. The User 1 and 2 signals are passed to a decoder 204. The decoder 204 is configured to decode both audio and video media signals. The decoder 204 evaluates the protocol of the User 1 and 2 signals and decodes the signals appropriately. The decoded User 1 and 2 signals are in the form of decompressed linear samples.

The decompressed linear samples related to the User 1 and 2 signals are passed to a mixer module 206. The mixer module 206 is responsible for combining the User 1 and 2 signals. This is accomplished by simple addition of the decompressed linear samples. The result of this addition is a mixed linear stream (User 1&2 signal). The User 1&2 signal is sent to the signal module 112.

The signal module 112 is equipped with an evaluation module 208 and the buffer module 114. The evaluation module 208 is responsible for evaluating the capabilities of user computing devices interfaced with the media server 104. In some instances, the module 208 evaluates a network bandwidth available to a user's computing device (e.g., a speed of the network connection and/or packet loss over the connection) and the capabilities of the computing device (e.g., processing capabilities). The module 208 may also evaluate the composition of a received signal and may make an accounting of a codec used to encode a signal. The evaluation module uses these various evaluation techniques to determine if an already encoded signal stored in the buffer module 114 may be selected in favor of encoding a given signal.

As described, the evaluation module 208 now has the User 1&2 signal. The evaluation module 208 may reference the receiving module 110 to determine that the User 1&2 signal is composed of media signals received from User 1 and User 2, respectively. The evaluation module 208 is now familiar with the composition of the User 1&2 signal.

The User 3 is to take delivery of the User 1&2 signal. Thus, the evaluation module 208 evaluates an amount of network bandwidth available to User 3's computing device 102. The module 208 also evaluates the processing capability of User 3's computing device 102.

The evaluation module 208 now has a number of evaluation parameters that may be compared against parameters associated with already encoded signals held in the buffer module 114. In this case, the evaluation module 208 searches the buffer module 114 for an appropriate already encoded signal, but does not locate one.

The evaluation module 208 passes the User 1&2 signal to the sending module 116 for encoding. The User 1&2 signal has associated parameters that include the network bandwidth available to User 3's computing device 102, the capabilities of the computing device 102, the composition of the User 1&2 signal, and a codec reference. An encoder 210 selects the referenced codec from a codec repository (not shown) and encodes the User 1&2 signal. The encoded User 1&2 signal is processed by an RTP module 212 and a packetizer module 214, and delivered to the User 3.

The sending module 116 also bundles the encoded User 1&2 signal with the associated parameters that include the network bandwidth available to a User 3's computing device, the capabilities of the computing device, the composition of the User 1&2 signal, and a codec reference. The bundle is sent to the Buffer module 114 and stored there for possible reuse.

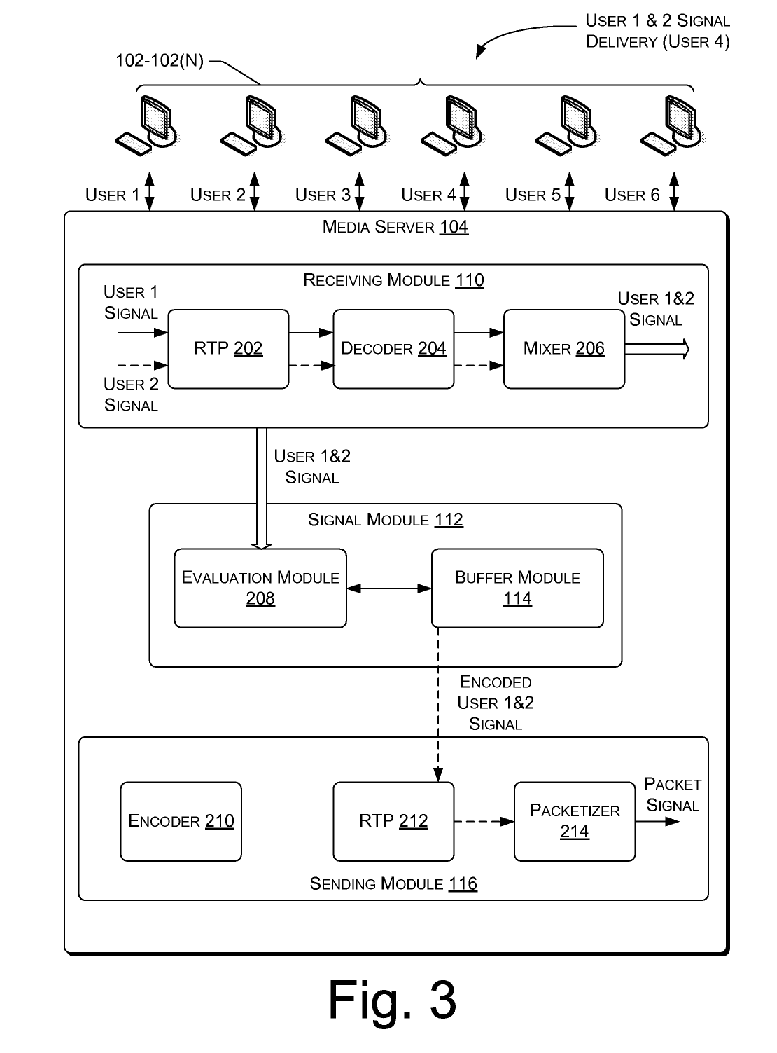

FIG. 3 illustrates a number of user computing devices 102 in communication with the media server 104. In this figure, the media server 104 is processing signals received from Users 1 and 2 and delivers an encoded signal to a User 4.

The media server 104 needs to ensure that the User 1&2 signal is delivered to the user computing devices 102 in a format that can be properly processed and consumed. The media server 104 has already accomplished this task for User 3's computing device 102 and is now ready to process the User 1&2 signal for delivery to User 4.

The evaluation module 208 evaluates the User 4's computing device 102 in the same manner described above in connection with the User 3's computing device 102. In particular, the evaluation module 208 evaluates an amount of network bandwidth available to User 4's computing device 102. The module 208 also evaluates the processing capability of User 4's computing device 102. The evaluation module 208 already knows, from the above, the composition of the User 1&2 signal.

The evaluation module 208 now has a number of evaluation parameters that may be compared against parameters associated with already encoded signals held in the buffer module 114. The evaluation module 208 searches the buffer module 114 for an appropriate already encoded signal and finds the encoded User 1&2 signal. The encoded User 1&2 signal is bundled with the associated parameters that include the network bandwidth available to User 3's computing device 102, the capabilities of the computing device 102, the composition of the User 1&2 signal, and a codec reference.

The evaluation module 208, based on a comparison of the evaluation parameters and the associated parameters bundled with the encoded User 1&2 signal, determines that the User 4 may receive the same encoded signal delivered to the User 3. The evaluation module 208 instructs the buffer module 114 to send the encoded User 1&2 signal to the sending module 116. The sending module 116 processes and sends the encoded User 1&2 signal to the User 4.

As can be understood from the foregoing, one encoding process was eliminated using the encoding-reuse principles described herein. Many more encoding processes may be eliminated as the described techniques are repeated for many destination client devices.

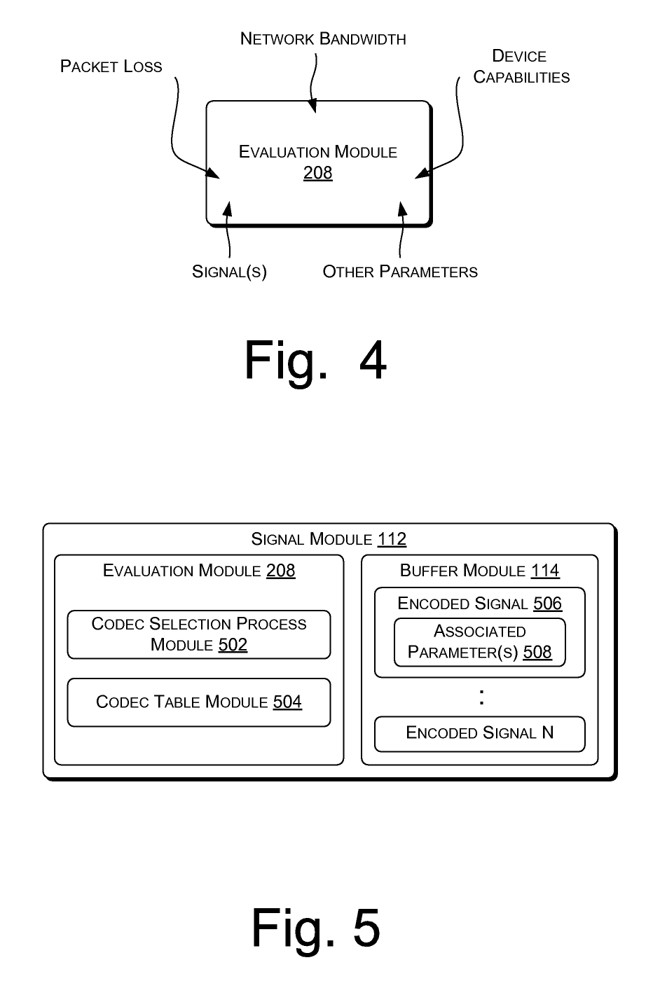

FIG. 4 illustrates various parameters that the evaluation module 208 may consider before selecting codecs used to encode media signals, or before selecting already encoded media signals stored in the buffer module 114. The inputs shown in the figure include packet loss, device capabilities, network bandwidth and signal composition. For video media signals, the various parameters may include frame rate, video size, bitrate, codec selection, and composition if the video is tiled. Techniques and methods for measuring the stated inputs are known to those skilled in the art. Nonetheless, a brief discussion of at least one measurement technique for determining packet loss, device capabilities and network bandwidth provided in the following. Determining a signal composition is discussed in the foregoing and will not be repeated. In one exemplary implementation, the evaluation module 208 performs the indicated measurements.

Packet loss may be measured using a special packet designed to get a response back from a destination computing device (e.g., a device 102), much like the echo of a sonar ping used to detect objects underwater. Such a special packet is often referred to as a “ping packet.” It is possible to send several (or even continuous) ping packets in succession over a network to a destination computing device. The number of responses returned from the destination computing device may be used to calculate an average packet loss of a current communication session.

Determining the capabilities of a computing device may be as simple as evaluating the raw processing power of a device's CPU. Such an evaluation will give a MIPS value or score. Higher MIPS values normally indicate higher performing computing devices. Other factors may also be used in determining a computing device's capabilities. These factors commonly include bus architecture, data bus width, and chip clocking values.

Measuring bandwidth available to a computing device can be fairly straightforward. One popular bandwidth measuring technique involves polling the technology facilitating communication with a network (e.g., the network 106). Polling of the facilitating technology generates feedback indicating a maximum bandwidth capability of the technology. Telephone modems, cable modems and DSL modems are a few examples of technologies that facilitate communication with a network.

FIG. 5 illustrates additional details of the signal module 112 discussed in detail with reference to FIGS. 1-3. As is illustrated in FIG. 5, the evaluation module 208 includes a codec selection-process module 502 and a codec table module 504. The codec selection-process module 502 has instructions for selecting codecs that are used to encode media signals; the codec table module 504 includes one or more codec tables that contain indexed references to codecs stored in a codec repository.

To illustrate an exemplary use of the modules 502 and 504, reference is made back to FIG. 2. The Evaluation module 208 evaluates the network bandwidth available to a User 3's computing device and the capabilities of the computing device upon receiving the User 1&2 signal. The codec selection process module 502 uses this information in selecting a codec reference from the codec table module 504. The User 1&2 signal, the codec reference and other associated parameters are sent to the encoder 210. The encoder 210 encodes the User 1&2 signal, as discussed hereinabove.

The buffer module 114 is also illustrated in FIG. 5. The buffer module 114 includes a number of already encoded signals 506 that include associated parameters 508. In certain circumstances, these already encoded signals 506 may be reused to avoid having to expend costly signal encoding processing resources. For example, if parameters evaluated by the evaluation module 208 substantially match the associated parameters 508 bundled with an already encoded signal 506, the encoded signal 506 may be sent to a destination computing device 102. This may eliminate having to encode a signal currently being processed by the evaluation module 208.

Exemplary Processes

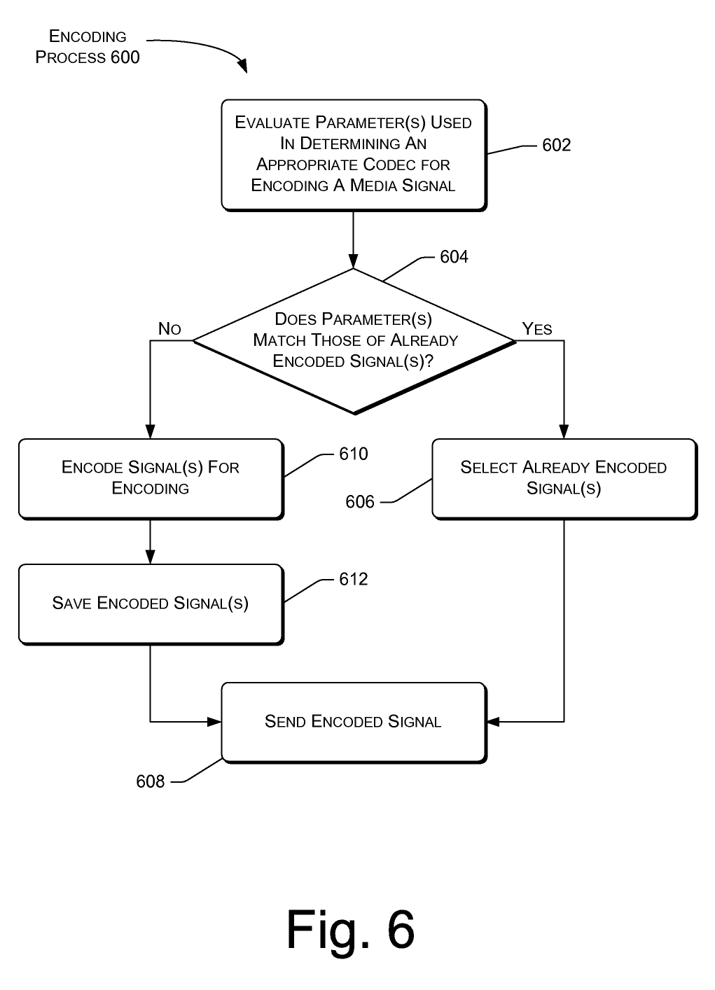

FIGS. 6-8 illustrate exemplary encoding processes that employ encoded-signal reuse policies. The processes are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation.

For discussion purposes, the processes are described with reference to the communication arrangement 100 of FIG. 1. In particular, many acts described below may be implemented and performed by various components of the media server 104 illustrated in FIGS. 1-5.

Referring to FIG. 6, a media signal encoding process 600 is illustrated. At block 602, the media server 104 evaluates one or more parameters that may be used when selecting an encoding procedure. The encoding procedure may be in the form of a codec useable to encode a media signal before it is communicated over a network. The one or more parameters evaluated may include a network bandwidth available to a user's computing device (e.g., a speed of the network connection and/or packet loss over the connection), the capabilities of the user's computing device (e.g., processing capabilities), and a composition of a signal that requires encoding.

At block 604, the media server 104 compares the evaluated one or more parameters with one or more parameters associated with an already encoded signal. Such an already encoded signal may be held in the buffer module 114, which is discussed in connection with the signal module 112. Recall, an already encoded signal may have an associated parameter that indicates a bandwidth level that the encoded signal is compatible with. In one implementation, the associated parameter is simply one of a high bandwidth or low bandwidth indicator. Therefore, at block 604, if a speed of the network connection is within the range 0-56 Kbps (low bandwidth), this evaluation parameter would match an associated parameter that is a low bandwidth indicator. Similarly, if a speed of the network connection is greater than 56 Kbps (high bandwidth), this evaluation parameter would match an associated parameter that is a high bandwidth indicator.

At block 606, if one or more of the evaluated parameters matches a parameter associated with an already encoded signal, the already encoded signal is selected. At block 608, the already encoded signal is sent to a destination computing device.

At block 610, if one or more of the evaluated parameters does not match a parameter associated an already encoded signal, a media signal undergoes encoding. At block 612, the encoded signal is saved for possible later use. At block 608, the encoded signal is sent to a destination computing device.

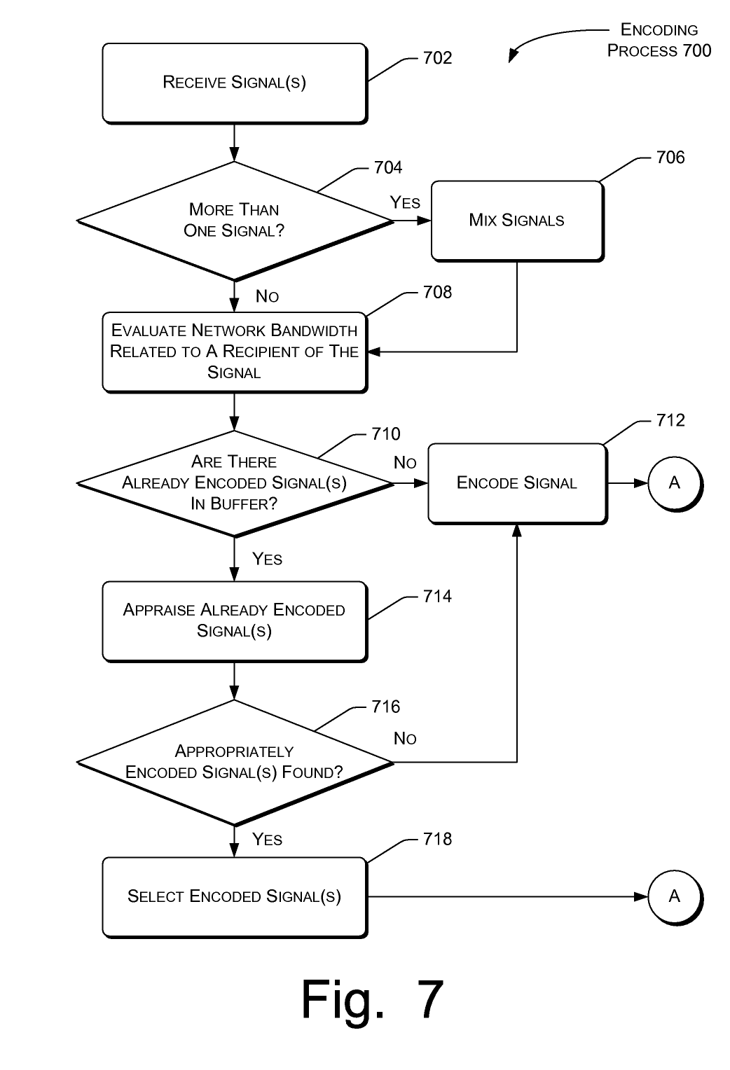

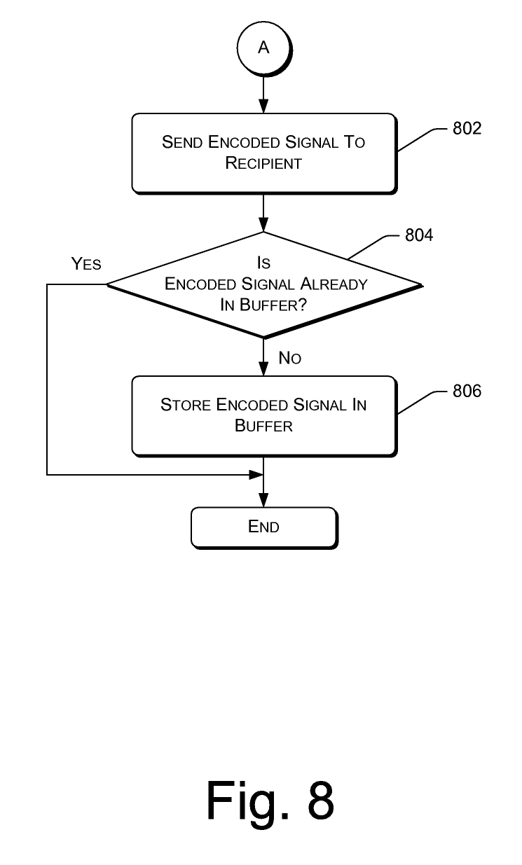

FIGS. 7-8 illustrate a media signal encoding process 700. At block 702, the media server 104 receives one or more media signals from one or more user computing devices. At block 704, the media server 104 determines if there are multiple media signals. For example, the media server 104 may receive two audio media signals that need to be communicated to many other users. At block 706, if multiple signals were received, the media server 104 mixes the signals.

At block 708, a network bandwidth available to a destination computing device is evaluated. As discussed herein, other parameters may be evaluated as well. In one implementation, the evaluation module 208 processes the instructions of block 708.

At block 710, the media server 104 determines if there are any already encoded signals in a buffer (e.g., the buffer module 114). If not, at block 712, the media server encodes the received signal(s). At block 714, if already encoded signals are contained in the buffer, the already encoded signals are evaluated to see if one or more of the encoded signals has an associated parameter (e.g., a network bandwidth parameter) that matches the network bandwidth determined at block 708. If one or more encoded signals have a matching network bandwidth parameter, an encoded signal can be chosen if the composition of the encoded signal, before it underwent encoding, matches the received signal(s).

If an already encoded signal is found in the buffer module 114 (block 716), the encoded signal is selected at block 718. Otherwise, at block 712, the received signal is encoded.

FIG. 8 illustrates the continuation of the encoding process 700. At block 804, the encoded signal (from block 712 or 718) is sent to the destination computing device. At block 804, the media server 104 determines if the encoded signal is already stored in the buffer module 114. It would be if the encoded signal sent at block 802 was delivered by the instructions of the block 718. The encoded signal with its associated parameter(s) is stored in the buffer module 114 at block 806. The block of FIGS. 7-8 may be repeated if additional computing devices required delivery of media signals.

Exemplary Computing Device

FIG. 9 is an illustrative computing device that may be used to implement the user computing devices 102 and the media server 104. In a very basic configuration, the computing device 900 includes at least one processing unit 902 and system memory 904. Depending on the exact configuration and type of computing device 900, the system memory 904 may be volatile (such as RAM), non-volatile (such as ROM and flash memory) or some combination of the two. The system memory 904 typically includes an operating system 906, one or more program modules 908, and may include program data 910.

For the present implementations, the program modules 708 may include the various modules and elements of the media server 104. Other modules described herein may also be part of the program modules 908.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 920 and non-removable storage 922. Computer storage media may include volatile and nonvolatile, removable and non-removable media implemented in any method or technology for storage of information, such as computer readable instructions, data structures, program modules, or other data. The system memory 906, removable storage 920 and non-removable storage 922 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of the device 900. Computing device 900 may also have input device(s) 924 such as keyboard, mouse, pen, voice input device, and touch input devices. Output device(s) 926 such as a display, speakers, printer, may also be included. These devices are well know in the art and need not be discussed at length.

The computing device 900 may also contain a communication connection 928 that allow the device to communicate with other computing devices 930, such as over a network like network 106 of FIG. 1. Communication connection(s) 928 is one example of communication media. Communication media may typically be embodied by computer readable instructions, data structures, program modules, or other data in a modulated data signal, such as a carrier wave or other transport mechanism, and includes any information delivery media.

Various modules and techniques may be described herein in the general context of computer-executable instructions, such as program modules, executed by one or more computers or other devices. Generally, program modules include routines, programs, objects, components, data structures, and so forth. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

Conclusion

The above-described systems and methods attempt to improve signal encoding by reducing how often media signals are encoded. When encoded signals are reused, a video conferencing system, or other media signal processing technology, may enjoy significantly reduced processing overhead. Reduced processing overhead generally increases a video conferencing system's responsiveness. Although the systems and methods have been described in language specific to structural features and/or methodological acts, it is to be understood that the systems and methods defined in the appended claims are not necessarily limited to the specific features or acts described. Rather, the specific features and acts are disclosed as exemplary forms of implementing the claimed system and method.

1. A method implemented at least in part by a computing device, comprising:
evaluating a parameter used to select a signal encoding procedure;
appraising at least one parameter associated with an already encoded signal; and
selecting the already encoded signal if the at least one parameter of the already encoded signal substantially matches the parameter used to select a signal encoding procedure.

2. The method of claim 1, wherein the act of evaluating evaluates a network bandwidth available to a computing device.

3. The method of claim 1, wherein the act of appraising appraises a parameter associated with an already encoded signal that indicates a network bandwidth that was available to a computing device before the already encoded signal underwent a signal encoding procedure.

4. The method of claim 1, wherein the evaluating act evaluates a network bandwidth available to a computing device and determines that the network bandwidth is considered a low-bandwidth connection, and the selecting act selects the already encoded signal if the at least one parameter of the already encoded signal identifies that the encoded signal is for use with low-bandwidth connections.

5. The method of claim 1, wherein the evaluating act evaluates a network bandwidth available to a computing device and determines that the network bandwidth is considered a high-bandwidth connection, and the selecting act selects the already encoded signal if the at least one parameter of the already encoded signal identifies that the encoded signal is for use with high-bandwidth connections.

6. The method of claim 1, further comprising encoding a media signal if the at least one parameter of the already encoded signal does not substantially match the parameter used to select a signal encoding procedure.

7. The method of claim 1, wherein the act of appraising appraises a parameter associated with an already encoded signal that indicates a signal composition of the already encoded signal before the already encoded signal underwent a signal encoding procedure.

8. The method of claim 1, wherein the act of appraising appraises a parameter associated with an already encoded signal that indicates a codec that was used to encode the already encoded signal.

9. The method of claim 1, wherein the act of appraising appraises at least one parameter associated with an already encoded signal, the at least one parameter being one of a high-bandwidth connection indicator or a low-bandwidth connection indicator.

10. Computer-readable media comprising instructions associated with a codec selection process, the instructions performing tasks when executed by a computing device, the tasks including selecting an already encoded signal to deliver to a computing device if encoding a signal would produce an encoded signal substantially the same as the already encoded signal.

11. The media of claim 10, wherein the task of selecting selects an already encoded signal to deliver to a computing device from a collection of already encoded signals.

12. The media of claim 10, wherein the task of selecting includes appraising at least one parameter associated with an already encoded signal.

13. The media of claim 10, wherein the task of selecting includes appraising a bandwidth indicator associated with an already encoded signal.

14. The media of claim 10, wherein the task of selecting includes appraising a bandwidth indicator associated with an already encoded signal, the bandwidth indicator being one of two available bandwidth indicators that may be associated with an already encoded signal.

15. The media of claim 10, wherein the task of selecting includes appraising a bandwidth indicator associated with an already encoded signal, the bandwidth indicator being one of two available bandwidth indicators that may be associated with an already encoded signal, the two available bandwidth indicators including a high bandwidth connection indicator and a low bandwidth connection indicator.

16. A media server, comprising:
at least one processor;
a memory accessible by the at least one processor; and
a buffer module stored in the memory, the buffer module including at least one already encoded signal, the at least one already encoded signal having an associated parameter used to select an encoding procedure that encoded the at least one already encoded signal.

17. The server of claim 16, wherein the associated parameter is one a composition of a media signal, a network bandwidth, a device capability score, and a codec reference.

18. The server of claim 16, further comprising a codec selection process module interfaced with the buffer module, the codec selection process module capable of selecting an already encoded signal if encoding a media signal would produce an encoded signal that substantially matches the already encoded signal.

19. The server of claim 16, wherein the codec selection process appraises at least one parameter associated with an already encoded signal before selecting an already encoded signal.

20. The server of claim 16, wherein the buffer is incorporated in a video conferencing system.
